(19) United States
(12) Patent Application Publication
(10) Pub. No.: US 2024/0267539 A1
(43) Pub. Date: Aug. 8, 2024

(54) IMAGE COMPRESSION APPARATUS AND METHOD

(71) Applicant: Hanwha Vision Co., Ltd., Seongnam-si (KR)

(72) Inventor: Byoung Man AN, Seongnam-si (KR)

(73) Assignee: Hanwha Vision Co., Ltd., Seongnam-si (KR)

(21) Appl. No.: 18/640,694

(22) Filed: Apr. 19, 2024

Related U.S. Application Data
(63) Continuation of application No. PCT/KR22/15993, filed on Oct. 20, 2022.

(30) Foreign Application Priority Data
Oct. 20, 2021 (KR) 10-2021-0140544

(51) Int. Cl. H04N 19/172; G06V 10/764; G06V 20/40; H04N 19/137; H04N 19/91

(52) U.S. Cl. CPC H04N 19/172; G06V 10/764; G06V 20/44; H04N 19/137; H04N 19/91

(57) ABSTRACT

Provided are an image compression method performed by an apparatus including at least one processor and at least one memory that stores instructions executable by the at least one processor. The method includes, receiving an event information of a captured image; encoding an image frame from the captured image; generating a meta-frame by encoding a mapping table corresponding to the event information; generating a transmission packet by combining the meta-frame with the encoded image frame; and transmitting the generated transmission packet, wherein the mapping table includes a first mapping table for encoding an object type for classifying at least one object included in the event information and a second mapping table for encoding a situation class for classifying a situation of the at least one object.

### CROSS-REFERENCE TO THE RELATED APPLICATION

This application is a bypass continuation application of International Application No. PCT/KR2022/015993 filed on Oct. 20, 2022, which claims priority to Korean Patent Application No. 10-2021-0140544, filed on Oct. 20, 2021, in the Korean Intellectual Property Office, the disclosure of which is incorporated by reference herein in its entirety.

### BACKGROUND

### 1. Field

The disclosure relates to image compression technology, and more particularly, to an apparatus and a method for compressing event information included in an image together with the image.

### 2. Description of the Related Art

In the related art, network camera devices are known to transmit metadata including image analysis results or event information together with image data captured by an imaging device through a network. Extensible Markup Language (XML) may be used as a format for the metadata, and Efficient XML Interchange (EXI), Binary MPEG format for XML (BiM), and Fast Infoset (FI) are known as technologies for compressing/extending XML documents.

However, metadata has only been expressed as a structured document such as XML and cannot be provided in a formatted form in relation to an actual image frame. In addition, although XML documents can be compressed and transmitted using a lossless coding method, the method is not a compression method optimized in consideration of an object or a situation included in various events.

In the related art, metadata secured separately from image data captured by a camera device is transmitted separately. Accordingly, the amount of information that must be transmitted increases. In addition, a system for ensuring synchronization and compatibility between a transmitting device and a receiving device is not available.

Therefore, there is a need to develop a method of standardizing metadata, which is transmitted together with image data captured by an imaging device, into a more structured format and improving compression efficiency of the metadata.

### SUMMARY

An aspect of the disclosure is to improve an overall data compression rate by mapping metadata or artificial intelligence (AI) information corresponding to a captured image into a standardized format.

Another aspect of the disclosure is to provide a systematic method of generating a packet by combining metadata corresponding to a captured image with a compressed image frame.

However, aspects of the disclosure are not restricted to the one set forth herein. The above and other aspects of the disclosure will become more apparent to one of ordinary skill in the art to which the disclosure pertains by referencing the detailed description of the disclosure given below.

According to an aspect of an example embodiment of the disclosure, there is provided an image compression method performed by performed by an apparatus including at least one processor and at least one memory that stores instructions executable by the at least one processor, the method including: receiving an event information of a captured image; encoding an image frame from the captured image; generating a meta-frame by encoding a mapping table corresponding to the event information; generating a transmission packet by combining the meta-frame with the encoded image frame; and transmitting the generated transmission packet, wherein the mapping table includes a first mapping table for encoding an object type for classifying at least one object included in the event information and a second mapping table for encoding a situation class for classifying a situation of the at least one object.

The object type in the first mapping table may have a first priority and a simpler code is mapped to an object type with a higher first priority, and the situation class in the second mapping table may have a second priority and a simpler code is mapped to a situation class with a higher second priority.

The meta-frame may include a field in which the first mapping table is recorded, a field in which the second mapping table is recorded, a field in which a probability that the object type of the first mapping table is correct is recorded, and a field in which a probability in which a situation class of the second mapping table is correct is recorded.

The meta-frame may be generated only for at least one image frame having the event information, among image frames, and whether an image frame has a meta-frame may be indicated by a flag bit.

The receiving the event information may include receiving first event information from a first event analysis source and receiving second event information from a second event analysis source, and the generating the meta-frame may include generating the meta-frame based on a reliability of the first event information and a reliability of the second event information being equal to or greater than a first threshold value.

The receiving the event information may include receiving first event information from a first event analysis source and receiving second event information from a second event analysis source, and the generating the meta-frame may include, in a case where one of a reliability of the first event information and a reliability of the second event information is less than a first threshold value, generating the meta-frame based on the other one of the reliability of the first event information and the reliability of the second event information being equal to or greater than a second threshold value higher than the first threshold value.

According to an aspect of an example embodiment of the disclosure, there is provided an image compression method performed by performed by an apparatus including at least one processor and at least one memory that stores instructions executable by the at least one processor, the method including: generating an event information of a captured image; encoding an image frame from the captured image; generating a meta-frame by losslessly encoding motion detection (MD) data and artificial intelligence (AI) data, the MD data and the AI data corresponding to the generated event information; generating a transmission packet by combining the meta-frame with the encoded image frame; and transmitting the generated transmission packet, wherein the MD data is a low-level event information obtained through motion detection between a plurality of image frames, and the AI data is a high-level event information obtained through AI learning.

The generating the meta-frame may include generating the meta-frame by selectively losslessly encoding at least one of the low-level event information or the high-level event information at a request of an image restoration device.

The MD data may include a first data field for identifying an image frame including an area in which a motion was detected, a second data field for recording a time when the motion was detected, and a third data field for recording a location of the area in which the motion was detected in the image frame.

The MD data may further include a fourth data field for recording at least one of a horizontal size or a vertical size of the area in which the motion was detected.

The AI data may include a first mapping table for encoding an object type for classifying at least one object included in the event information and a second mapping table for encoding a situation class for classifying a situation of the at least one object.

The object type in the first mapping table may have a first priority and a simpler code is mapped to an object type with a higher first priority, and the situation class in the second mapping table may have a second priority and a simpler code is mapped to a situation class with a higher second priority.

The meta-frame may include a field in which the first mapping table is recorded, a field in which the second mapping table is recorded, a field in which a probability that the object type of the first mapping table is correct is recorded, and a field in which a probability that the situation class of the second mapping table is correct is recorded.

The meta-frame may be generated only for at least one image frame having the event information, among image frames, and whether an image frame has a meta-frame may be indicated by a flag bit.

The receiving the event information may include receiving first event information from a first event analysis source and a second event analysis source, and the generating the meta-frame may include generating the meta-frame based on a reliability of the first event information and a reliability of the second event information being equal to or greater than a first threshold value.

The receiving the event information may include receiving first event information from a first event analysis source and a second event analysis source, and the generating the meta-frame may include, in a case where one of a reliability of the first event information and a reliability of the second event information is less than a first threshold value, generating the meta-frame based on the other one of the reliability of the first event information and the reliability of the second event information being equal to or greater than a second threshold value higher than the first threshold value.

The losslessly encoding the MD data and the AI data may be performed by an entropy coding unit in a video encoder which encodes the image frame.

According to an aspect of an example embodiment of the disclosure, there is provided an image compression apparatus including: at least one memory configured to store thereon one or more computer program code; and at least one processor configured to access the at least one memory and operate according to the one or more computer program code, wherein the one or more computer program code causes the at least one processor to perform: acquiring an event information of a captured image; encoding an image frame from the captured image; generating a meta-frame by encoding a mapping table corresponding to the event information; generating a transmission packet by combining the meta-frame with the encoded image frame; and transmitting the generated transmission packet, wherein the mapping table includes a first mapping table for encoding an object type for classifying at least one object included in the event information and a second mapping table for encoding a situation class for classifying a situation of the at least one object.

The generating the meta-frame may include generating the meta-frame by losslessly encoding artificial intelligence (AI) data corresponding to the event information, the AI data being a high-level event information obtained through AI learning, and the AI data may include the first mapping table and the second mapping table.

The generating the meta-frame may include generating the meta-frame by further losslessly encoding motion detection (MD) data corresponding to the event information, the MD data being a low-level event information obtained through motion detection between a plurality of image frames.

According to the disclosure, when generating a packet by combining a captured image with metadata, it is possible to standardize them in a structured format and, at the same time, improve a compression rate.

In addition, according to the disclosure, metadata generated together with a captured image is prioritized in consideration of importance. Therefore, scalable transmission of the metadata is possible.

In addition, according to the disclosure, whether an event exists in a corresponding image frame may be more accurately determined by considering metadata provided from a plurality of event analysis sources.

### BRIEF DESCRIPTION OF DRAWINGS

The above and other aspects, features, and advantages of certain example embodiments of the disclosure will be more apparent from the following description taken in conjunction with the accompanying drawings, in which:

FIG. 1 is a block diagram of an image compression apparatus according to an example embodiment of the disclosure;

FIG. 2 illustrates a first mapping table for encoding object types according to an example embodiment of the disclosures;

FIG. 3 illustrates a second mapping table for encoding situation classes according to an example embodiment of the disclosures;

FIG. 4 illustrates a format of an encoded meta-frame according to an example embodiment of the disclosure;

FIG. 5 is a detailed block diagram of a video encoder of FIG. 1;

FIG. 6 is a block diagram illustrating a hardware configuration of a computing device that implements an image compression apparatus according to an example embodiment of the disclosure;

FIG. 7 is a flowchart illustrating an image compression method according to an example embodiment of the disclosure;

FIG. 8A illustrates a format of an encoded meta-frame according to another example embodiment of the disclosure;

FIG. 8B illustrates a configuration of motion detection (MD) data in a meta payload according to another example embodiment of the disclosures;

FIG. 8C illustrates a configuration of artificial intelligence (AI) data in the meta payload according to another example embodiment of the disclosures;

FIG. 9 is a block diagram for explaining functions of a video encoder, a meta-frame generator, and a transmission packet generator included in the image compression apparatus of FIG. 1; and

FIG. 10 is a flowchart illustrating an image compression method according to another example embodiment of the disclosure.

### DETAILED DESCRIPTION

Advantages and features of the disclosure and methods to achieve them will become apparent from the descriptions of example embodiments herein below with reference to the accompanying drawings. However, the inventive concept is not limited to example embodiments disclosed herein but may be implemented in various ways. The example embodiments are provided for making the disclosure of the inventive concept thorough and for fully conveying the scope of the inventive concept to those skilled in the art. It is to be noted that the scope of the disclosure is defined by the claims and their equivalents. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

Hereinafter, example embodiments of the disclosure will be described in detail with reference to the accompanying drawings.

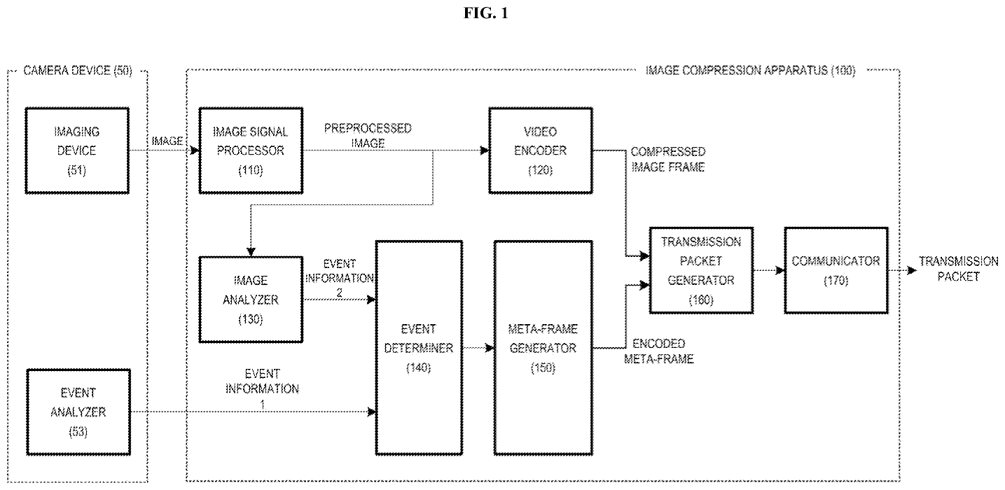

FIG. 1 is a block diagram of an image compression apparatus 100 according to an example embodiment of the disclosure.

The image compression apparatus 100 may include, in terms of hardware, a processor and a memory that stores instructions executable by the processor and may include, as functional blocks, an image signal processor (DSP) 110, a video encoder 120, an event analyzer (or image analyzer) 130 as an event analysis source, an event determiner 140, a meta-frame generator 150, a transmission packet generator 160, and a communicator 170. For example, in the image compression apparatus 100, the functional blocks may be performed by the instructions under the control of the processor.

A camera device 50 includes an imaging device 51 and an event analyzer 53. An image (e.g., video or still image) captured by the imaging device 51 such as a charge coupled device (CCD) or a complementary metal-oxide semiconductor (CMOS) and event information obtained through video analytics by the event analyzer 53 as an event analysis source may be provided to the image compression apparatus 100. The event information is metadata that may express the content of the image obtained from the captured image and may include an object type, an event situation, etc.

In FIG. 1, a case where the camera device 50 is implemented as a separate device from the image compression apparatus 100 is illustrated as an example. However, the disclosure is not limited to this case, and the camera device 50 may also be integrated into or embedded in the image compression apparatus 100.

First, the image compression apparatus 100 receives an image captured by the camera device 50 and receives first event information generated by the camera device 50.

The received image may be input to the image signal processor 110. The image signal processor 110 may preprocess the received image and then provide the preprocessed image to the video encoder 120 and the event analyzer 130. The preprocessing may include white balance, up/down sampling, noise reduction, contrast improvement, etc.

The video encoder 120 may encode the preprocessed image and output a compressed image frame. In addition, the event analyzer 130 may be installed in the image compression apparatus 100 separately from the event analyzer 53 in the camera device 50. The event analyzer 130 may generate second event information by performing video analytics on the preprocessed image.

That is, if a system-on-chip (SoC) inside the image compression apparatus 100 and the camera device 50 (e.g., provided outside the image compression apparatus 100) may each generate event information, first and second event information may be generated. The generated first and second event information may be provided to the event determiner 140. The event determiner 140 determines whether an event is included in a current image frame based on the first and second event information. Specifically, the event determiner 140 may determine that an event is included in the current image frame only when both the reliability of the first event information and the reliability of the second event information are equal to or greater than a first threshold value (e.g., 80%) and may instruct the meta-frame generator 150 to generate an encoded meta-frame. On the other hand, if the reliability of the first event information is lower than the first threshold value or the reliability of the second event information is lower than the first threshold value, the event determiner 140 may determine that an event is not included in the image frame and instruct the meta-frame generator 150 not to generate a meta-frame for the current image frame (or may not instruct the meta-frame generator 150 to generate the meta-frame for the current image frame).

As another example, even if all of the reliabilities of the two pieces of event information do not satisfy the condition of being equal to or greater than the first threshold value, the event determiner 140 may determine that an event is included in the current image frame when, even if any one of the reliability of the first event information and the reliability of the second event information is less than the first threshold value, the other one is equal to or greater than a second threshold value (e.g., 90%) higher than the first threshold value and may instruct the meta-frame generator 150 to generate an encoded meta-frame. On the other hand, if any one of the reliabilities of the first and second event information is lower than the first threshold value and all of the reliabilities of the first and second event information are lower than the second threshold value (higher than the first threshold value), the event determiner 140 may determine that an event is not included in the image frame and instruct the meta-frame generator 150 not to generate a meta-frame for the current image frame.

In general, each manufacturer of an event analyzer may have a different algorithm for judging objects, and different reliabilities (probabilities) may be obtained from different algorithms. Therefore, more accurate judgment results may be obtained by using the reliabilities of two pieces of event information as described above.

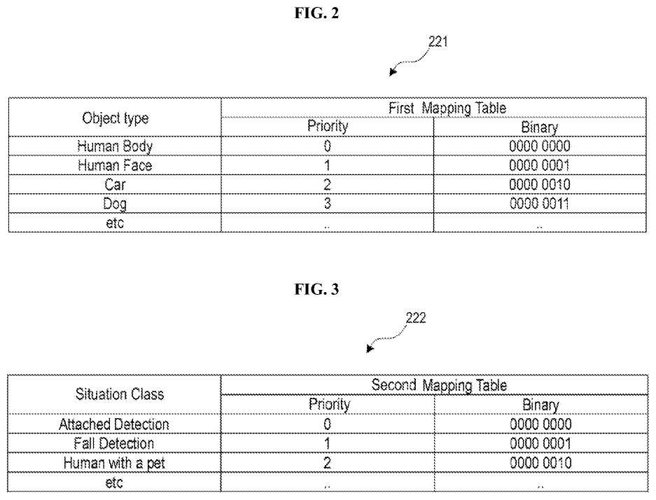

When the event determiner 140 determines that event information is included in the current image frame, the meta-frame generator 150 may generate an encoded meta-frame by encoding a mapping table corresponding to the event information. Therefore, since the meta-frame is generated not for all image frames, but only for image frames having event information, unnecessary information overhead may be prevented. A more detailed configuration of the meta-frame will be described in more detail later with reference to FIGS. 2 through 4 which will be described later.

Whether a meta-frame corresponding to a specific image frame is included may be indicated by, for example, a flag bit. Therefore, an image restoration device corresponding to the image compression apparatus 100 may identify whether the meta-frame is included by checking the flag bit. Thus, accurate data reading is possible.

The transmission packet generator 160 may generate a transmission packet by combining a compressed image frame and an encoded meta-frame. If there is no encoded meta-frame for a specific image frame, the transmission packet generator 160 may simply generate a transmission packet using only the image frame.

In FIG. 1, the video encoder 120 and the meta-frame generator 150 may generate a compressed image frame and an encoded meta-frame, respectively, and provide them to the transmission packet generator 160. Here, a generated meta-frame may be losslessly encoded within the meta-frame generator 150. However, since the video encoder 120 has an entropy coding unit for losslessly encoding a compressed image, the generated meta-frame may also be provided to the video encoder 120 so that the video encoder 120 generates an encoded meta-frame and provides the encoded meta-frame to the transmission packet generator 160.

The communicator 170 may transmit a generated transmission packet through a network. The image restoration device receiving the transmission packet may read a meta-frame and a compressed image frame at a correct bit position after reading the flag bit and finally generate a restored image frame and event information corresponding to the restored image frame. The communicator 170 may be an interface communicably connected to an external device to transmit a transmission packet and may include a transmission control protocol/Internet protocol (TCP/IP), a Real-Time Streaming Protocol (RTSP), a physical layer, etc.

An encoded meta-frame generated by the meta-frame generator 150 of FIG. 1 may include a first mapping table for encoding an object type for classifying at least one object included in the event information and a second mapping table for encoding a situation class for classifying a situation the at least one object is in. Here, a mapping table basically means data (e.g., binary data) in which event information or artificial intelligence (AI) information is mapped into a formatted table when encoding and decoding are performed at a transmitting side and a receiving side of a captured image.

FIG. 2 illustrates a first mapping table 221 for encoding object types according to an example embodiment of the disclosures. The first mapping table 221 may be a table that maps object types such as human body, human face, car, dog, etc. to binary codes. The object types may be prioritized, and a simpler code may be mapped to an object type with a higher priority. For example, the human body with the highest priority may be assigned the simplest binary code “0000 0000”, and the human face with the next highest priority may be assigned the next simplest binary code “0000 0001”. In this way, if a large number of simple binary codes are generated by giving priority to objects that are likely to occur frequently, compression efficiency may further be increased during lossless coding such as entropy coding.

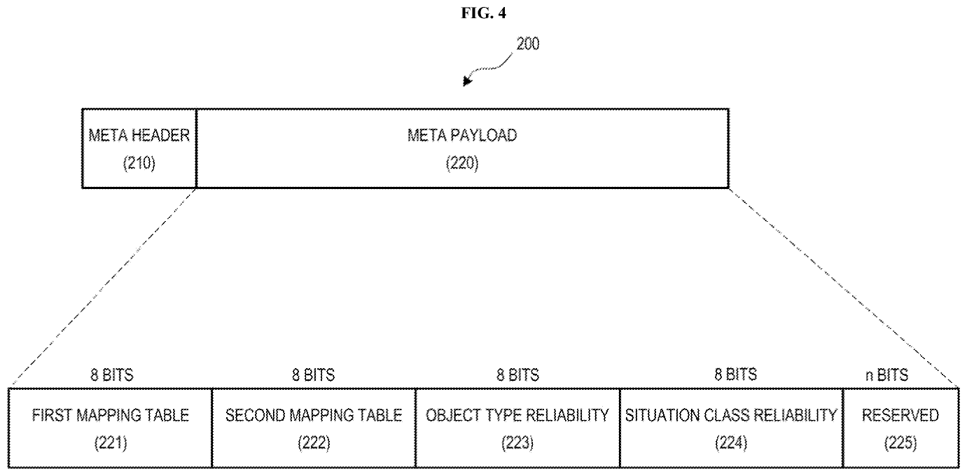

FIG. 3 illustrates a second mapping table 222 for encoding situation classes according to an example embodiment of the disclosures. The second mapping table 222 may be a table that maps situation classes such as attached detection, fall detection, human with a pet, etc. to binary codes. The situation classes may be prioritized, and a simpler code may be mapped to a situation class with a higher priority. For example, the attached detection with the highest priority may be assigned the simplest binary code “0000 0000”, and the fall detection with the next highest priority may be assigned the next simplest binary code “0000 0001”. In this way, if a large number of simple binary codes are generated by giving priority to situations that are likely to occur frequently, compression efficiency may further be increased during lossless coding such as entropy coding.

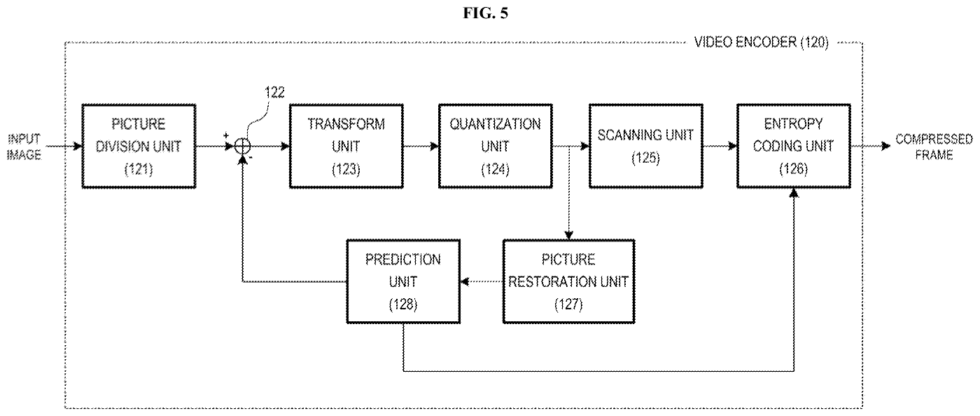

FIG. 4 illustrates, in detail, the format of an encoded meta-frame 200 according to an example embodiment of the disclosure. The meta-frame 200 may include a meta header 210 and a meta payload 220. The meta header 210 is a structured format in which information necessary to read the meta payload 220 is recorded. The meta payload 220 is a structured format in which actual payload data is recorded.

The meta payload 220 includes at least the first mapping table 221 and the second mapping table 222 described above. In addition, the meta payload 220 may further include an object type reliability field 223 indicating the reliability of object types in the first mapping table 221, a situation class reliability field 224 indicating the reliability of situation classes in the second mapping table 222, and a reserved bit 225. For example, the first mapping table 221, the second mapping table 222, the object type reliability field 223, and the situation class reliability field 224 may each be represented by 8 bits.

The reliability may be expressed as a percentage value indicating the probability that an object type or a situation class is correct. Alternatively, in order to reduce the amount of data of the reliability, the reliability may be expressed as a simple representative number. For example, the representative number may be displayed as “0” when the reliability is close to 100%, “1” when the reliability is 90% or more, and “2” when the reliability is in the range of 80 to 90%.

In addition, the reserved bit 225 may be an area for recording custom data that may be additionally expressed according to the circumstances of the manufacturer of the image compression apparatus or the image restoration device.

If the object type reliability 223 or the situation class reliability 224 is transmitted to the image restoration device in addition to the mapping tables 221 and 222, the image restoration device at the receiving end may perform variable processing to extract only highly reliable event information according to its own standards. Therefore, this variable processing may be adaptively used in various scenarios such as, for example, when only the first mapping table 221 is read to identify object types, when only the first and second mapping tables 221 and 222 are read to identify object types and situation classes, or when not only the mapping tables 221 and 222 but also the reliability information 223 and 224 are read to extract more accurate objects and situations, according to the purpose and specifications of the image restoration device at the receiving end.

Alternatively, even within one mapping table 221 or 222, the image restoration device may read and process only binary data with a high priority at the front and may not consider objects or situations with a low priority. That is, the format illustrated in FIG. 4 may provide a scalable attribute to the meta-frame.

On the other hand, the scalable attribute may also be applied to the image compression apparatus 100. For example, if the image compression apparatus 100 has limited or insufficient specifications, only the binary data with a high priority at the front in the mapping tables 221 and 222 may be transmitted. Alternatively, the entire first and second mapping tables 221 and 222 may be transmitted, but the reliability fields 223 and 224 following the mapping tables 221 and 222 may be omitted.

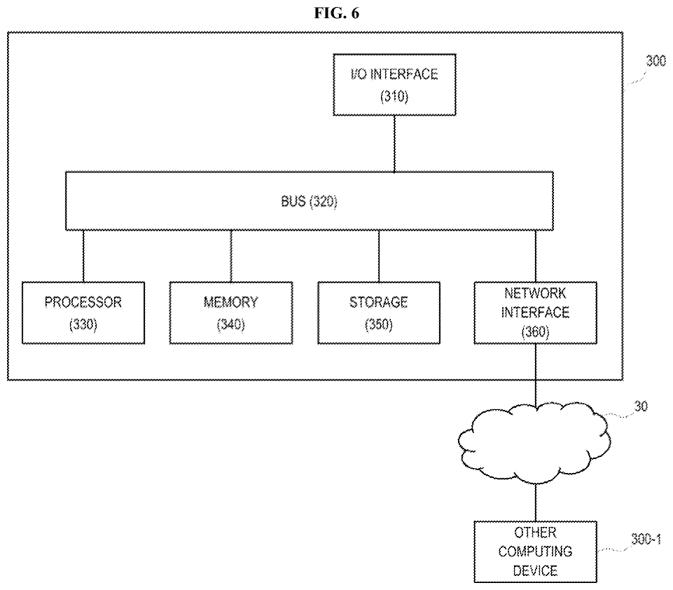

FIG. 5 is a detailed block diagram of the video encoder 120 of FIG. 1. The video encoder 120 may be a hardware or software module that generates a compressed image frame from an image signal according to various video coding standards such as MPEG-2, MPEG-4, H.264, and HEVC (H.265).

Referring to FIG. 5, the video encoder 120 may include a picture division unit 121, a subtractor 122, a transform unit 123, a quantization unit 124, a scanning unit 125, an entropy coding unit 126, a picture restoration unit 127, and a prediction unit 128.

The picture division unit 121 may analyze an input video signal and divide a picture into blocks of a predetermined size. The unit of division may be a variable block size including 16×16, 8×8 and 4×4 as in H.264, but may also have larger and more diverse block sizes as in HEVC.

The subtractor 122 may generate a residual block by subtracting a prediction block provided by the prediction unit 128 from an original block.

The transform unit 123 may generate transform coefficients having frequency components by spatially transforming the residual block. The spatial transformation may typically use discrete cosine transform (DCT), discrete sine transform (DST), wavelet transform (WT), etc.

The quantization unit 124 may determine a quantization step size for each encoding unit to quantize the transform coefficients. Then, the quantization unit 124 may generate quantization coefficients by quantizing the coefficients of the transformed block according to the determined quantization step size.

The scanning unit 125 may scan the quantization coefficients (two-dimensional array) in a predetermined manner (e.g., zigzag, horizontal, vertical scan, etc.) and convert the quantization coefficients into one-dimensional quantization coefficients.

The entropy coding unit 126 may generate a compressed bitstream by entropy-encoding (losslessly encoding) the one-dimensional quantization coefficients scanned by the scanning unit 125 and prediction information provided by the prediction unit 128. The prediction information may refer to information according to intra prediction or inter prediction, and specifically, to mode information in intra prediction or motion vector and reference picture information in inter prediction.

According to a typical closed-loop coding method, an original picture itself may not be used as a reference picture. Instead, the picture may be restored through transformation and quantization and then inverse quantization and inverse transformation, and the restored picture may be used as a reference for another picture or the same picture. Using another part of the same picture as a reference is called intra prediction, and using another picture as a reference is called inter prediction.

The picture restoration unit 127 may obtain a restored picture (or part of the picture) by performing inverse quantization and inverse transformation on the two-dimensional quantization coefficients obtained through transformation and quantization. The restored picture may be provided to the prediction unit 128. The prediction unit 128 may generate a reference picture using a more advantageous prediction method in terms of rate-distortion (R-D) cost among intra prediction and inter prediction and provide the reference picture to the subtractor 122.

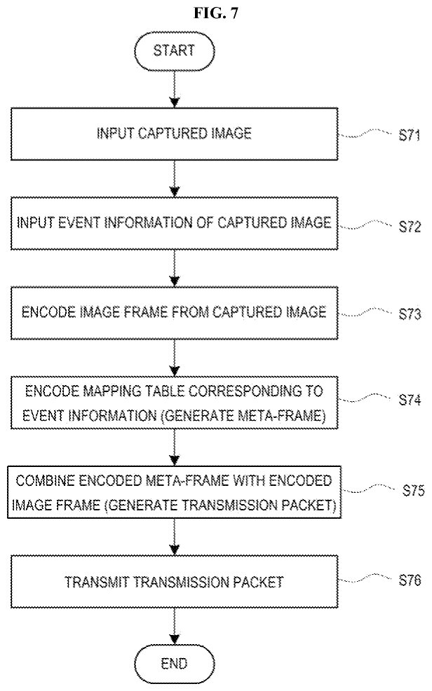

FIG. 6 is a block diagram illustrating the hardware configuration of a computing device 300 that implements an image compression apparatus 100 according to an example embodiment.

Referring to FIG. 6, a computing device 300 includes a bus 320, a processor 330, a memory 340, a storage 350, an input/output interface 310, and a network interface 360. The bus 320 may provide a path for the transmission of data between the processor 330, the memory 340, the storage 350, the input/output interface 310, and the network interface 360. However, it is not particularly limited how the processor 330, the memory 340, the storage 350, the input/output interface 310, and the network interface 360 are connected. The processor 330 may be an arithmetic processing unit such as a central processing unit (CPU) or a graphics processing unit (GPU). The memory 340 may be a memory such as a random-access memory (RAM) or a read-only memory (ROM). The storage 350 may be a storage device such as a hard disk, a solid state drive (SSD), or a memory card. The storage 350 may also be a memory such as a RAM or a ROM.

The input/output interface 310 may be an interface for connecting the computing device 300 and an input/output device. For example, a keyboard or a mouse may be connected to the input/output interface 310.

The network interface 360 may be an interface for communicatively connecting the computing device 300 and an external device to exchange transport packets with each other. The network interface 360 may be a network interface for connection to a wired line or for connection to a wireless line. For example, the computing device 300 may be connected to another computing device 300-1 via a network 30.

The storage 350 stores program modules that implement the functions of the computing device 300. The processor 330 implements the functions of the computing device 300 by executing the program modules. Here, the processor 330 may read the program modules in the memory 340 and may then execute the program modules.

The hardware configuration of the computing device 300 is not particularly limited. For example, the program modules may be stored in the memory 340. In this example, the computing device 300 may not include the storage 350.

The image compression apparatus 100 may at least include the processor 330 and the memory 340, which stores instructions that may be executed by the processor 330. The image compression apparatus 100 of FIG. 1, in particular, may be driven by executing instructions including a variety of functional blocks or steps included in the image compression apparatus 100, via the processor 330.

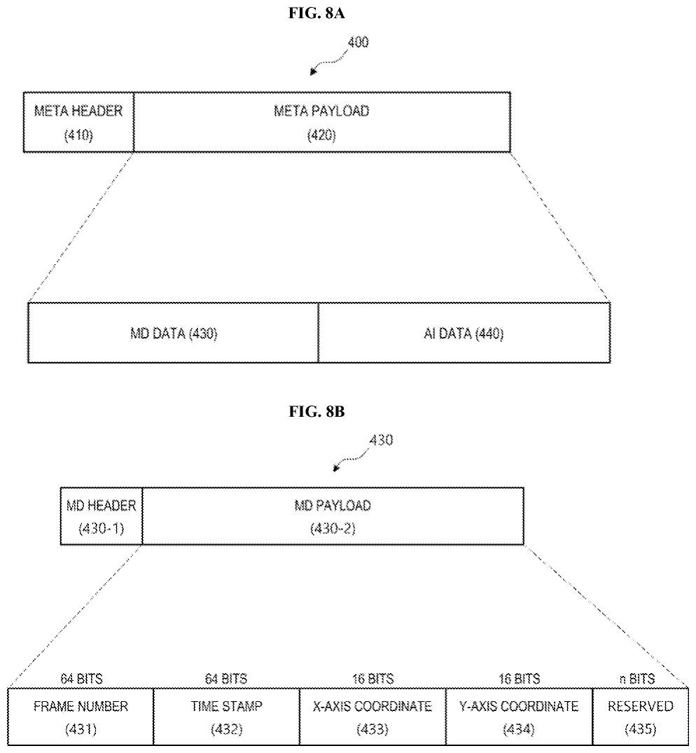

FIG. 7 is a flowchart illustrating an image compression method according to an example embodiment of the disclosure. In an apparatus including a processor 330 and a memory 340 that stores instructions executable by the processor 330, the image compression method performed by the instructions under the control of the processor 330 may include operations illustrated in FIG. 7.

First, an image signal processor 110 may receive an image captured by a camera device 50 (operation S71). In addition, an event determiner 140 may receive event information (event information 1) of the captured image (operation S72). Alternatively, an event analyzer 130 may generate event information (event information 2) from the captured image, and the event determiner 140 may receive the generated event information (operation S72).

A video encoder 120 may encode an image frame from the captured image (operation S73).

A meta-frame generator 150 may generate a meta-frame by encoding a mapping table corresponding to the event information (operation S74).

A transmission packet generator 160 may generate a transmission packet by combining the meta-frame with the encoded image frame (operation S75).

A communicator 170 may transmit the generated transmission packet to an image restoration device (operation S76).

Here, the mapping table may include a first mapping table 221 for encoding an object type for classifying at least one object included in the event information and a second mapping table 222 for encoding a situation class for classifying a situation the at least one object is in.

The object type in the first mapping table 221 may have a first priority, and a simpler code may be mapped to an object type with a higher first priority. The situation class in the second mapping table 222 may have a second priority, and a simpler code may be mapped to a situation class with a higher second priority.

Here, the meta-frame 200 includes a field 221 in which the first mapping table is recorded, a field 222 in which the second mapping table is recorded, a field 223 in which the probability (reliability) that the object type(s) of the first mapping table is correct is recorded, and a field 224 in which the probability (reliability) that the situation class(es) of the second mapping table is correct is recorded.

The meta-frame 200 may be generated only for image frames having the event information among image frames, and whether an image frame has a meta-frame may be indicated by a flag bit.

In the above embodiment, a case where the meta payload 220 included in the losslessly encoded meta-frame 200 includes AI data such as the first and second mapping tables 221 and 222, the object type reliability 223 and the situation class reliability 224 as illustrated in FIG. 4 has been described as an example. However, the meta payload 220 is not limited to this example. For example, the meta payload 220 may further include motion detection (MD) data in addition to the AI data. In this case, the MD data as well as the AI data may be losslessly encoded through a mapping table similar to those of FIGS. 2 and 3.

The MD data, like the AI data, belongs to metadata (event information) about events obtained through video analytics. However, the MD data may be obtained through image processing technology such as analysis of motion between a plurality of frames without using an AI algorithm that provides various functions for object and event identification. Therefore, the MD data may simply extract only an area where a motion was detected regardless of the type of object. However, the disclosure is not limited thereto, and basic object classification information may be further included in the MD data.

While the AI data may be high-level event information obtained through AI learning that requires high specifications, the MD data may be low-level event information that may be obtained even from a low-specification system that does not have a neural processing unit (NPU) or does not support AI learning. The MD data may include the location of a motion detection area obtained through comparison between a plurality of images, an identification number of a frame including the motion detection area, and the time of occurrence of the motion detection.

An image compression apparatus 100 according to a second embodiment of the disclosure may selectively provide high-level event information and/or low-level event information at the request of an image restoration device such as a network video recorder (NVR) or a video management system (VMS).

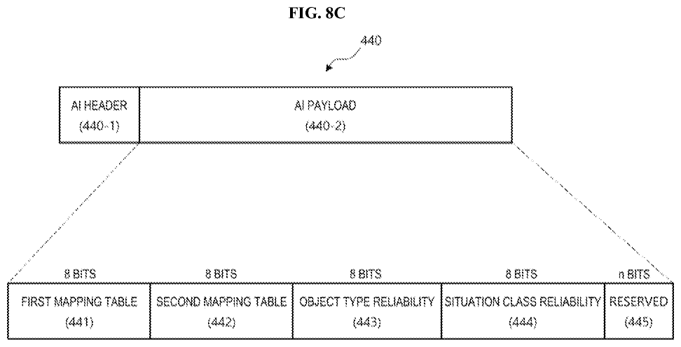

FIG. 8A illustrates the format of an encoded meta-frame 400 according to a second embodiment of the disclosure. FIG. 8B illustrates the configuration of MD data 430 in a meta payload 420. FIG. 8C illustrates the configuration of AI data 440 in the meta payload 420.

As illustrated in FIG. 8A, the meta-frame 400 may include a meta header 410 and the meta payload 420, and the meta payload 420 may include the encoded MD data 430 and the encoded AI data 440.

In addition, as illustrated in FIG. 8B, the MD data 440 may include an MD header 430-1 and an MD payload 430-2. Here, the MD header 430-1 may be a structured format in which information necessary to read the MD payload 430-2 is recorded, and the MD payload 430-2 may be a structured format in which actual payload data is recorded.

The MD payload 430-2 may include, for example, a 64-bit frame number field 431, a 64-bit time stamp field 432, a 16-bit X-axis coordinate field 433, and a 16-bit Y-axis coordinate field 434. When a motion is detected in a specific image, a frame number corresponding to the image is recorded in the frame number field 431. In addition, the time when the motion was detected may be recorded in the time stamp 432, and the location of an area where the motion was detected within the image, that is, an X-axis coordinate and a Y-axis coordinate may be recorded in the X-axis coordinate field 433 and the Y-axis coordinate 434, respectively. The location may simply be expressed as a point, but may also include the size of the area. Therefore, the X-axis coordinate and the horizontal size of the area may be recorded in the X-axis coordinate field 433, and the Y-axis coordinate and the vertical size of the area may be recorded in the Y-axis coordinate field 434.

In addition, a reserved bit 435 may be an area for recording custom data that may be additionally expressed according to the circumstances of the manufacturer of the image compression apparatus or the image restoration device.

In addition, as illustrated in FIG. 8C, the AI data 440 may include an AI header 440-1 and an AI payload 440-2. Here, the AI header 440-1 may be a structured format in which information necessary to read the AI payload 440-2 is recorded, and the AI payload 440-2 may be a structured format in which actual payload data is recorded.

The AI payload 430-2, like the meta payload 220 of FIG. 4, may include a first mapping table 441, a second mapping table 442, an object type reliability field 443, a situation class reliability field 444, and a reserved bit 445. Since their contents may be the same as or similar to those in FIG. 4, a redundant description thereof will be omitted.

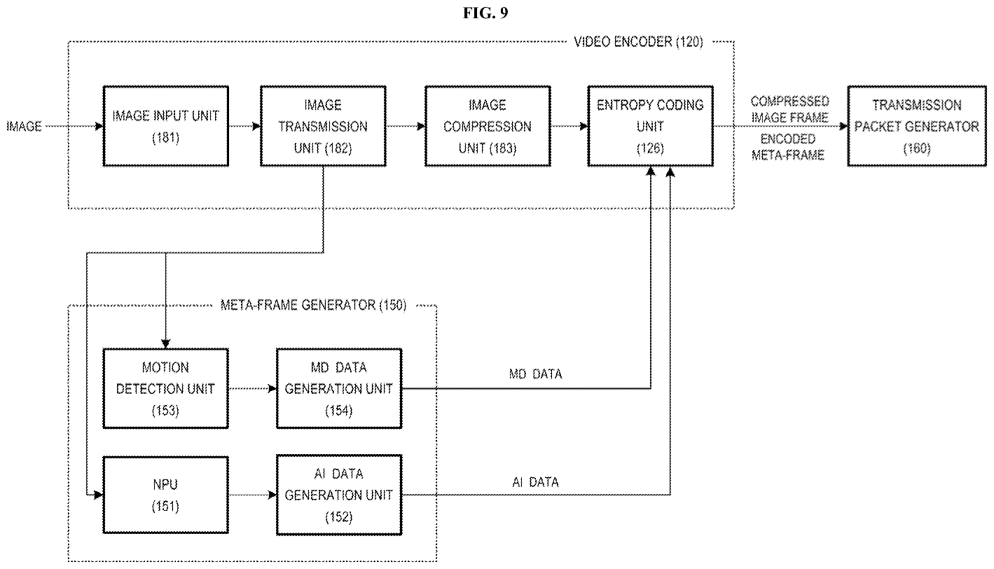

FIG. 9 is a block diagram for explaining detailed functions of the video encoder 120, the meta-frame generator 150, and the transmission packet generator 160 included in the image compression apparatus 100 of FIG. 1.

The video encoder 120 may include an image input unit 181, an image transmission unit 182, an image compression unit 183, and an entropy coding unit 184. The meta-frame generator 150 may include an NPU 151, an AI data generation unit 152, a motion detection unit 153, and an MD data generation unit 154. For example, the meta-frame generator 150 of FIG. 9 may be understood as encompassing functional blocks that generate event information from an input image, like the event analyzer 130 and the event determiner 140 of FIG. 1.

The image input unit 181 may receive an image captured by the camera device 50. The captured image may be converted by the image input unit 181 into various image formats such as black and white, RGB, and YUV according to specifications supported by the video encoder 120. In addition, the image transmission unit 182 may transmit the input image to the meta-frame generator 150.

The NPU 151 included in the meta-frame generator 150 may perform AI learning and/or AI inference on the received image. For the AI learning, labeled data obtained from a large number of images may be input into a neural network, and the neural network may be repeatedly trained by changing network parameters. If the result of learning falls within a desired reliability range, the network parameters may be stored. Later, in the AI inference process, an actual image may be input to the neural network having the network parameters to obtain the determination result.

Through the AI learning and inference, the type and reliability (probability) of an identified object and the type and reliability (probability) of an event (situation class) may be obtained. This information may be recorded by the AI data generation unit 152 in the format of the AI payload 440-2 as illustrated in FIG. 8C.

The motion detection unit 153 may detect an area where there is a motion in the input image through a separate algorithm from the NPU 151 or by using the NPU 151. This motion area may be obtained by detecting only an area where there is a motion through a difference value between a plurality of successive image frames, that is, a motion vector.

Information about the area where there is a motion may be recorded by the MD data generation unit 154 in the format of the MD payload 430-2 as illustrated in FIG. 8B.

The image compression unit 183 may compress the input image using a predetermined codec. The image compression unit 183 may include the blocks 121 through 127 located in front of the entropy coding unit 126 in FIG. 5.

The compressed image may be input to the entropy coding unit 126, and MD data and AI data generated by the meta-frame generator 150 may also be input to the entropy coding unit 126.

The entropy coding unit 126 may generate a compressed bitstream by performing lossless coding (entropy coding) on the compressed image, the MD data, and the AI data. The lossless coding techniques include Huffman coding, arithmetic coding, run-length coding, and Golomb coding.

A compressed image frame and an encoded meta-frame produced by the video encoder 120 as described above may be input to the transmission packet generator 160. The transmission packet generator 160 may generate a transmission packet having the compressed image frame and the encoded meta-frame as payload. The transmission packet may refer to a data structure formatted according to a protocol such as Transport Stream, Real-Time Streaming Protocol (RTSP), or Hypertext Transfer Protocol 2.0 (HTTP2) to enable data communication between two devices connected on a network.

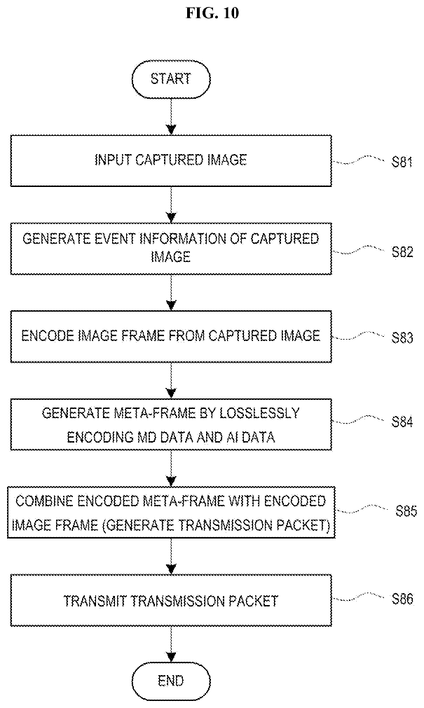

FIG. 10 is a flowchart illustrating an image compression method according to a second embodiment of the disclosure. In an apparatus including a processor 330 and a memory 340 that stores instructions executable by the processor 330, the image compression method performed by the instructions under the control of the processor 330 may include operations illustrated in FIG. 10.

First, an image signal processor 110 may receive an image captured by a camera device 50 (operation S81), and a meta-frame generator 150 may generate event information of the captured image (operation S82). The event information may include MD data generated by an MD data generation unit 154 and AI data generated by an AI data generation unit 152 in the meta-frame generator 150.

The MD data may include a first data field 431 for identifying an image frame including an area where a motion was detected, a second data field 432 for recording the time when the motion was detected and a third data field 433 and 434 for recording the location of the area where the motion was detected in the image frame and may further include a fourth data field 433 and/or 434 (provided in one data field or separate data fields) for recording horizontal and vertical sizes of the area where the motion was detected.

Next, a video encoder 120 may encode an image frame from the captured image (operation S83). In addition, the meta-frame generator 150 may generate a meta-frame by losslessly encoding the MD data and/or the AI data corresponding to the event information (operation S84).

A transmission packet generator 160 may generate a transmission packet by combining the meta-frame with the encoded image frame (operation S85). Finally, a communicator 170 may transmit the generated transmission packet to an image restoration device (operation S86).

The MD data may be low-level event information obtained through motion detection between a plurality of image frames, and the AI data may be high-level event information obtained through AI learning. In an example embodiment of the disclosure, when generating the meta-frame in operation S84, the meta-frame generator 150 may generate the meta-frame by selectively losslessly encoding at least one of the low-level event information and the high-level event information at the request of the image restoration device.

The AI data may include a first mapping table 221 for encoding object types for classifying objects included in the event information and a second mapping table 222 for encoding situation classes for classifying situations the objects are in.

The object types in the first mapping table 221 may have a first priority, and a simpler code may be mapped to an object type with a higher first priority. The situation classes in the second mapping table 222 may have a second priority, and a simpler code may be mapped to a situation class with a higher second priority.

Here, the meta-frame 200 may include a field 221 in which the first mapping table is recorded, a field 222 in which the second mapping table is recorded, a field 223 in which the probability (reliability) that the object types in the first mapping table are correct is recorded, and a field 224 in which the probability (reliability) that the situation classes in the second mapping table are correct is recorded.

However, the meta-frame 200 may be generated only for image frames having the event information among image frames, and whether an image has a meta-frame may be indicated by a flag bit.

Many modifications and other embodiments of the disclosure may be made by one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

What is claimed is:

1. An image compression method performed by an apparatus comprising at least one processor and at least one memory that stores instructions executable by the at least one processor, the method comprising:
receiving an event information of a captured image;
encoding an image frame from the captured image;
generating a meta-frame by encoding a mapping table corresponding to the event information;
generating a transmission packet by combining the meta-frame with the encoded image frame; and
transmitting the generated transmission packet,
wherein the mapping table comprises a first mapping table for encoding an object type for classifying at least one object included in the event information and a second mapping table for encoding a situation class for classifying a situation of the at least one object.

2. The image compression method of claim 1, wherein the object type in the first mapping table has a first priority and a simpler code is mapped to an object type with a higher first priority, and the situation class in the second mapping table has a second priority and a simpler code is mapped to a situation class with a higher second priority.

3. The image compression method of claim 2, wherein the meta-frame comprises a field in which the first mapping table is recorded, a field in which the second mapping table is recorded, a field in which a probability that the object type of the first mapping table is correct is recorded, and a field in which a probability in which a situation class of the second mapping table is correct is recorded.

4. The image compression method of claim 1, wherein the meta-frame is generated only for at least one image frame having the event information, among image frames, and whether an image frame has a meta-frame is indicated by a flag bit.

5. The image compression method of claim 1, wherein the receiving the event information comprises receiving first event information from a first event analysis source and receiving second event information from a second event analysis source, and
wherein the generating the meta-frame comprises generating the meta-frame based on a reliability of the first event information and a reliability of the second event information being equal to or greater than a first threshold value.

6. The image compression method of claim 1, wherein the receiving the event information comprises receiving first event information from a first event analysis source and receiving second event information from a second event analysis source, and
wherein the generating the meta-frame comprises, in a case where one of a reliability of the first event information and a reliability of the second event information is less than a first threshold value, generating the meta-frame based on the other one of the reliability of the first event information and the reliability of the second event information being equal to or greater than a second threshold value higher than the first threshold value.

7. An image compression method performed by an apparatus comprising at least one processor and at least one memory that stores instructions executable by the at least one processor, the method comprising:
generating an event information of a captured image;
encoding an image frame from the captured image;
generating a meta-frame by losslessly encoding motion detection (MD) data and artificial intelligence (AI) data, the MD data and the AI data corresponding to the generated event information;
generating a transmission packet by combining the meta-frame with the encoded image frame; and
transmitting the generated transmission packet,
wherein the MD data is a low-level event information obtained through motion detection between a plurality of image frames, and the AI data is a high-level event information obtained through AI learning.

8. The image compression method of claim 7, wherein the generating the meta-frame comprises generating the meta-frame by selectively losslessly encoding at least one of the low-level event information or the high-level event information at a request of an image restoration device.

9. The image compression method of claim 7, wherein the MD data comprises a first data field for identifying an image frame comprising an area in which a motion was detected, a second data field for recording a time when the motion was detected, and a third data field for recording a location of the area in which the motion was detected in the image frame.

10. The image compression method of claim 9, wherein the MD data further comprises a fourth data field for recording at least one of a horizontal size or a vertical size of the area in which the motion was detected.

11. The image compression method of claim 7, wherein the AI data comprises a first mapping table for encoding an object type for classifying at least one object included in the event information and a second mapping table for encoding a situation class for classifying a situation of the at least one object.

12. The image compression method of claim 11, wherein the object type in the first mapping table has a first priority and a simpler code is mapped to an object type with a higher first priority, and the situation class in the second mapping table has a second priority and a simpler code is mapped to a situation class with a higher second priority.

13. The image compression method of claim 12, wherein the meta-frame comprises a field in which the first mapping table is recorded, a field in which the second mapping table is recorded, a field in which a probability that the object type of the first mapping table is correct is recorded, and a field in which a probability that the situation class of the second mapping table is correct is recorded.

14. The image compression method of claim 7, wherein the meta-frame is generated only for at least one image frame having the event information, among image frames, and whether an image frame has a meta-frame is indicated by a flag bit.

15. The image compression method of claim 7, wherein the receiving the event information comprises receiving first event information from a first event analysis source and a second event analysis source, and
wherein the generating the meta-frame comprises generating the meta-frame based on a reliability of the first event information and a reliability of the second event information being equal to or greater than a first threshold value.

16. The image compression method of claim 7, wherein the receiving the event information comprises receiving first event information from a first event analysis source and a second event analysis source, and
wherein the generating the meta-frame comprises, in a case where one of a reliability of the first event information and a reliability of the second event information is less than a first threshold value, generating the meta-frame based on the other one of the reliability of the first event information and the reliability of the second event information being equal to or greater than a second threshold value higher than the first threshold value.

17. The method of claim 7, wherein the losslessly encoding the MD data and the AI data is performed by an entropy coding unit in a video encoder which encodes the image frame.

18. An image compression apparatus comprising:
at least one memory configured to store thereon one or more computer program codes; and
at least one processor configured to access the at least one memory and operate according to the one or more computer program codes, wherein the one or more computer program codes are configured to cause the at least one processor to perform:
acquiring an event information of a captured image;
encoding an image frame from the captured image;
generating a meta-frame by encoding a mapping table corresponding to the event information;
generating a transmission packet by combining the meta-frame with the encoded image frame; and
transmitting the generated transmission packet,
wherein the mapping table comprises a first mapping table for encoding an object type for classifying at least one object included in the event information and a second mapping table for encoding a situation class for classifying a situation of the at least one object.

19. The image compression apparatus of claim 18, wherein the generating the meta-frame comprises generating the meta-frame by losslessly encoding artificial intelligence (AI) data corresponding to the event information, the AI data being a high-level event information obtained through AI learning, and
wherein the AI data comprises the first mapping table and the second mapping table.

20. The image compression apparatus of claim 18, wherein the generating the meta-frame comprises generating the meta-frame by further losslessly encoding motion detection (MD) data corresponding to the event information, the MD data being a low-level event information obtained through motion detection between a plurality of image frames.
